(19) United States
(12) Patent Application Publication
(10) Pub. No.: US 2013/0132820 A1
(43) Pub. Date: May 23, 2013

(54) Web browsing tool delivering relevant content

(71) Applicant: Eric Poindessault, Paris (FR)

(72) Inventor: Eric Poindessault, Paris (FR)

(21) Appl. No.: 13/507,139

(22) Filed: Jun. 7, 2012

(51) Int. Cl. G06F 17/00

(52) U.S. Cl. 715/234

(57) ABSTRACT

In accordance with the principles of the present invention, a client-side internet tool that enables people to browse the web is provided. A web page is requested from a web server. The user device receives a markup language document for the requested web page. The web page is rendered. The content of the web page is parsed to generate keywords. The keywords are directed to a content provider in a search request. The client device receives the processed search request results from the content provider. A frame is created within the web page. With the information obtained from the content provider, content is inserted in the frame. The frame with the content is rendered. This Abstract is submitted with the understanding that it will not be used to interpret or limit the scope or meaning of the claims.

### FIELD OF THE INVENTION

The present invention relates to tools for browsing the Internet.

### BACKGROUND OF THE INVENTION

The Internet is a global network of computers. Network servers support hypertext capabilities that permit the Internet to link together webs of documents. User interfaces such as Graphical User Interfaces (GUI) are typically used to navigate the Internet to retrieve relevant documents. Uniform Resource Locators (URLs) are used to identify specific websites and web pages on the Internet. URLs also identify the address of the document to be retrieved from a network server. The Transfer Control Protocol/Internet Protocol (TCP/IP) is used to transfer information.

The Internet uses a hypertext language referred to as the hypertext mark-up language (HTML). HTML is a commonly used scripting or programming language that permits content providers or developers to place hyperlinks within web pages. These hyperlinks link related content or data, which may be found on multiple Internet host computers. HTML document links may retrieve remote data by use of HyperText Transfer Protocol (HTTP). Alternatively, File Transfer Protocol (FTP) for file transfer, the network news protocol (NNTP) for discussion groups, and the simple mail transport protocol (SMTP) for email or other Internet application protocols can be used. When a user clicks on a link in a web document, the link icon in the document contains the URL that the client employs to initiate the session with the server storing the linked document. HTTP is the protocol used to support the information transfer.

While most of today's users of the Internet believe it is a recent communications phenomenon, the origins of the Internet actually go back several decades. Today's Internet grew out a computer resource-sharing network created in the 1960s by the Advanced Research Projects Agency (ARPA). This computer resource-sharing network, which came to be known as the ARPAnet, was primarily designed by ARPA's chief scientist, Larry Roberts. The initial problem facing a wide-area computer resource-sharing network was how to efficiently transmit digitized information in a reliable way. To solve this problem, in 1968, Roberts mandated use of a packet-switching design in the ARPAnet.

Packet switching breaks up blocks of digitized information into smaller pieces called packets. These packets are transmitted through the network, usually by different routes, and are then reassembled at their destination. Eight years prior to ARPA's Request for Proposal, Len Kleinrock invented packet switching. See, e.g., Len Kleinrock, “Information Flow in Large Communications Nets,” RLE Quarterly Progress Report (1960); Len Kleinrock, Communication Nets (1964). See also Paul Baren, “On Distributed Communications Networks,” IEEE Transactions on Systems (March 1964). Roberts believed that packet switching was the means to efficiently transmit digitized information in a reliable way.

The next problem to solve was how to interconnect a number of mainframe computers, most of which utilized different languages and different operating systems. Wesley Clark of Washington University in St. Louis, Mo. devised the solution to this huge incompatibility problem. Clark proposed that a smaller microcomputer should interface between every mainframe and the network. All of these minicomputers would run on the same operating system and use the same language. Each mainframe, therefore, would only be required to interface with its own minicomputer, with the minicomputer translating into the network operating system and language. These Interface Message Processors (IMP), which provided an interface between the ARPAnet host mainframe computers and the ARPAnet, were the predecessors to today's routers. With this basic design, the first two nodes on the ARPAnet communicated on 1 Oct. 1969.

By 1971, 15 nodes, mostly academic institutions, were up on the ARPAnet; however, the original goal of the ARPAnet was not being realized. Resource sharing of the mainframe computers was simply too cumbersome. In March 1972, Ray Tomlinson of consulting firm Bolt, Beranek & Newman invented e-mail. Use of this message transfer program quickly grew to be the initial major use of the ARPAnet.

By the mid-seventies, the ARPAnet was not the only network utilizing switching packets. Once again, an incompatibility problem emerged. Each of these different networks used a different protocol. Thus, interconnection of these different networks was not possible. The solution, devised by Robert Kahn of ARPA and Vincent Cerf of Stanford University, was called the Transmission Control Protocol/Internet Protocol. The Transmission Control Protocol packetized information and reassembled the information upon arrival. The Internet Protocol routed packets by encasing the packets between networks. See, e.g., Robert Kahn and Vincent Cerf, “A Protocol for Packet Network Intercommunication,” IEEE Transactions on Communications Technology (May 1974). Transmission Control Protocol/Internet Protocol was adopted by the ARPAnet in 1983. With the addition of the Domain Name System (DNS) in November 1983, the now familiar Internet address protocol was established.

A final step in creating the Internet occurred in 1990, when an Englishman, Tim Berners-Lee working at the European Center for Particle Research (CERN) in Switzerland, invented the World Wide Web. This software, based on a program Berners-Lee had written in 1980 to allow users to store information using random associations, allowed material from any computer, from any format to be translated into a common language of words, images, and addresses. Berners-Lee's program established the three core components of the World Wide Web: the Universal Resource Locator, Hypertext Transfer Protocol, and HyperText Markup language.

More recent innovations include: the founding in October 1994 by Tim Berners-Lee of the World Wide Web Consortium (W3C), an international community where member organizations, a full-time staff, and the public work together to develop Web standards; the introduction in December 1995 of the JavaScript species of ECMAScript, developed by Brendan Eich of Netscape, a prototype-based, object-oriented scripting language; the introduction on 26 Jan. 2000 by the W3C of the eXtensible HyperText Markup Language (XHTML), a family of XML markup languages that mirror or extend versions of the HTML; the development from 2000-20002 of the XMLHttpRequest, an API available in web browser scripting languages used to send HTTP or HTTPS requests directly to a web server and load the server response data directly back into the script; the founding in 2004 of the Web Hypertext Application Technology Working Group (WHATWG), a community of people focusing on the development of HTML and APIs needed for Web applications; and the ongoing development of the latest revision of the HTML standard, HTML5.

Information on the World Wide Web is found through the use of search engines. The usefulness of a search engine depends on the relevance of the search results. While there are millions of web pages that include a search query, some pages may be more relevant, popular or authoritative. Thus, it would be desirable to offer tools that allows for a better user experience when browsing the Internet.

### SUMMARY OF THE INVENTION

The present invention allows for a better user experience when browsing the Internet. A web page is requested from a web server. The user device receives a markup language document for the requested web page. The web page is rendered. The content of the web page is parsed to generate keywords. The keywords are directed to a content provider in a search request. The client device receives the processed search request results from the content provider. A frame is created within the web page. With the information obtained from the content provider, content is inserted in the frame. The frame with the content is rendered.

This Summary introduces concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWING

FIG. 1 is a schematic diagram of a system for providing relevancy of content to a user of a web browser navigating on a website, in accordance with an embodiment of the invention.

FIG. 2 is an interaction diagram of a process for providing relevancy of content to a user of a web browser navigating on a website, in accordance with an embodiment of the invention.

FIG. 3 is a flow chart of a process for providing relevancy of content to a user of a web browser navigating on a website, in accordance with an embodiment of the invention.

FIG. 4 is a screen shot of an example browser application with an example website.

FIG. 5 is a screen shot with an example rendered frame of additional links with information with respect to the example website of FIG. 4, generated from the process of FIGS. 2 and 3.

FIG. 6 is a screen shot with an example website chosen from the rendered frame of additional links of FIG. 5.

### DETAILED DESCRIPTION OF A PREFERRED EMBODIMENT

As previously introduced, information on the World Wide Web is found through the use of search engines. The search results are generally presented in a list of results often referred to a results page. The information may consist of web pages, images, information, and other types of files. Some search engines also mine data available in databases or open directories. Unlike web directories, which are maintained by human editors, search engines maintain real-time information by running an algorithm on a web crawler. A web crawler is an automated web browser that follows every link on the site.

Web search engines store information about many web pages, which are retrieved from their markup language documents (HTML, XHTML, etc.) source code itself. These pages are retrieved by the web crawler. The contents of each page are analyzed to determine how the page should be indexed (for example, words can be extracted from the titles, page content, headings or special fields called meta tags). Data about web pages or documents are stored in an index database for use in later queries. A query can be a single word, multi-words, words connected by Boolean operators, a specified phrase, and the like.

When a user enters a query into a search engine, the engine examines its index and provides a listing of best-matching web pages according to some criteria, typically with a short summary containing the title of the document and sometimes parts of the text. The index is built from the information stored with the data and the method by which the information is indexed.

The usefulness of a search engine depends on the relevance of the search results. The present invention provides a client-side interne tool that enables people to browse the web in a different fashion, offering users relevant links to access content directly related to the content viewed on a web page. Examples of sources where searches for content occur include search engines such as Google, made available by Google Inc., 1600 Amphitheatre Parkway, Mountain View, Calif. 94043; Bing, made available by Microsoft Corporation, One Microsoft Way, Redmond, Wash. 98052; Exalead, made available by Dassault Systèmes, 10 rue Marcel Dassault, 78140 Vélizy-Villacoublay, France; Altavista for websites, made available by Yahoo! Inc., 701 First Avenue, Sunnyvale, Calif. 94089; video providers such as YouTube, made available by Google Inc.; Dailymotion, made available by Dailymotion, 49/51 rue Ganneron, 75018 Paris, France; news providers such as Yahoo News, made available by Yahoo! Inc.; CNN, made available by Time Warner Inc., One Time Warner Center, New York, N.Y. 10019; and so on.

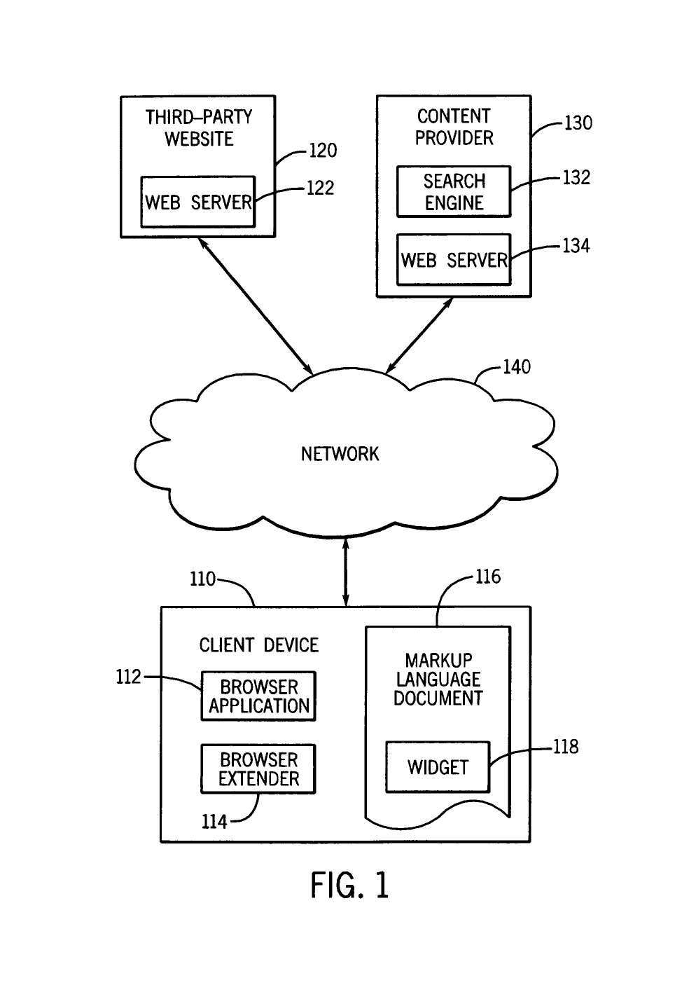

FIG. 1 is a schematic diagram of a system for providing relevancy of content to a user navigating on a website 120, in accordance with an embodiment of the invention. The system includes one or more user client devices 110, one or more third-party websites 120, one or more content providers 130, and a network 140. For purposes of illustration, the embodiment of the system shown by FIG. 1 includes a single third-party website 120 and a single content provider 130; however, in other embodiments the system may include many more third-party websites 120 and many more content providers 130.

The client device 110 comprises one or more computing devices that can receive input from a user and can transmit and receive data via the network 140. For example, the client device 110 may be a desktop computer, a laptop computer, a smartphone, a personal digital assistant (PDA) or any other device including computing functionality and data communication capabilities. The client device 110 is configured to communicate with the third-party website 120 and the content providers 130 via the network 140. The network 140 may comprise any combination of local area and/or wide area networks, using both wired and wireless communication systems.

In one embodiment, the user device 110 displays content from the third-party website 120 by processing a markup language document 116 received from the third-party website 120 using a browser 120. The markup language document 116 identifies content and one or more instructions describing formatting or presentation of the content. By executing the instructions included in the markup language document 116, the browser 112 displays the identified content using the format or presentation described by the markup language document 116. For example, the markup language document 116 includes instructions for generating and displaying a web page having multiple frames that include text and/or image data retrieved from the third-party website 120. In various embodiments, the markup language document 116 comprises a data file including XML data, XHTML data or other markup language data.

The client device 110 also includes a browser extender 114 described in detail below. The browser extender 114 can relate to any form of software, be it a plugin, extension or user script installed or executed in a web browser, or a third-party software interacting with a web browser. The browser extender 114 performs keyword searching functionality as known in the art.

The third-party website 120 comprises one or more web servers including one or more web pages 122. The web pages 122 are communicated to the user device 110 using the network 140. The third-party website 120 is separate from the content provider 130. For example, the third-party website 120 is associated with a first domain while the content provider 130 is associated with a separate social networking domain. A web server 122 included in the third-party website 120 comprises markup language documents identifying content and including instructions specifying formatting or presentation of the identified content, as described above.

The client device 110 includes a widget 118 comprising instructions that, when executed by a browser 112, retrieves data from the content provider 130 and displays the information retrieved from the content provider 130. For example, the widget 118 comprises an instruction associated with the content provider 130 that generates a frame that includes information from the content provider 130. Hence, the widget 118 allows a web page 122 from the third-party website 120 to provide relevant content using information from the content provider 130 when the web page 122 is rendered and displayed by a browser 112 of a user device 110. Further detail on the widget is provided below.

The content provider 130 comprises a search engine 132 and one or more web servers 134 including one or more web pages. The web pages are communicated to the client device 110 using the network 140. The third-party website 120 comprises one or more web servers 122 including one or more web pages. The web pages are communicated to the client device 110 using the network 140. In other embodiments, the third-party websites 120 and the content providers 130 may be operated by the same entity. The web page 122 included in the third-party website 120 comprises a markup language document identifying content and including instructions specifying formatting or presentation of the identified content, as described above.

The system for providing relevancy of content to a user navigating on a website described herein is exemplary. The techniques described herein are not inherently related to any particular hardware or other apparatus. In certain aspects, the techniques described herein may be implemented using hardware or a combination of software and hardware, or integrated into another entity, or distributed across multiple entities.

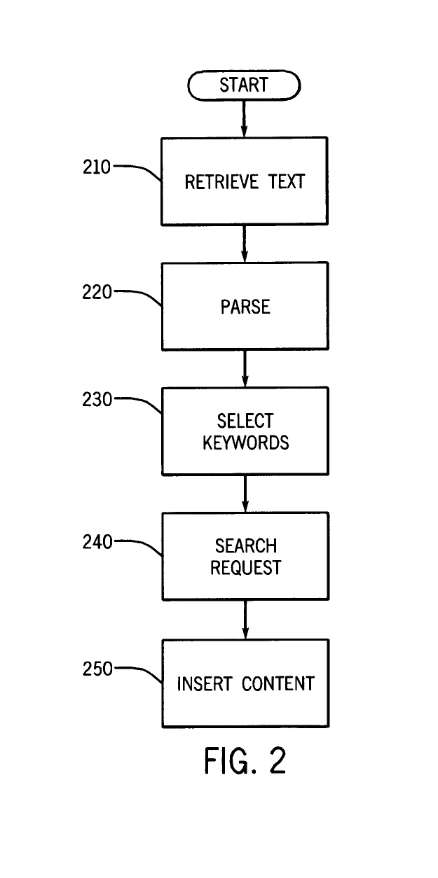

FIG. 2 is a flow chart of one embodiment of a process for obtaining focused information from a content provider 130. The browser 112 receives markup language documents 116 including text content from a web page 122 as the web page loads (210). The browser extender 114 instantaneously parses the content of web pages while the web pages are loading, in order to determine the keywords with which to prepare search requests (220). Parsing (also known as syntactic analysis) refers to the process of analyzing text to determine the logical structure of that text and identify sequences of tokens. A token is a string of characters distinguishable as a basic unit of a language. In the present case, parsing applies to markup languages like HTML, XML, XHTML, and combinations thereof. The browser extender 114 selects relevant keywords from the text content (230) and sends search requests to content providers (240). The browser extender 114 then generates content based on the search results received from the content providers 130 and inserts the content into an iframe loaded inside the web page itself (250).

The process for providing relevancy of content to a user navigating on a website described herein is exemplary. The techniques described herein are not limited to any particular programming language. A computer program implementing techniques described herein does not necessarily correspond to a file in a file system. A program can be stored in a portion of a file that holds other programs or data (for example, one or more scripts stored in a markup language document), in a single file dedicated to the program in question, or in multiple coordinated files (for example, files that store one or more modules, subprograms or portions of code). A computer program can be deployed to be executed on one computer or on multiple computers that are located at one site or distributed across multiple sites and interconnected by a communication network.

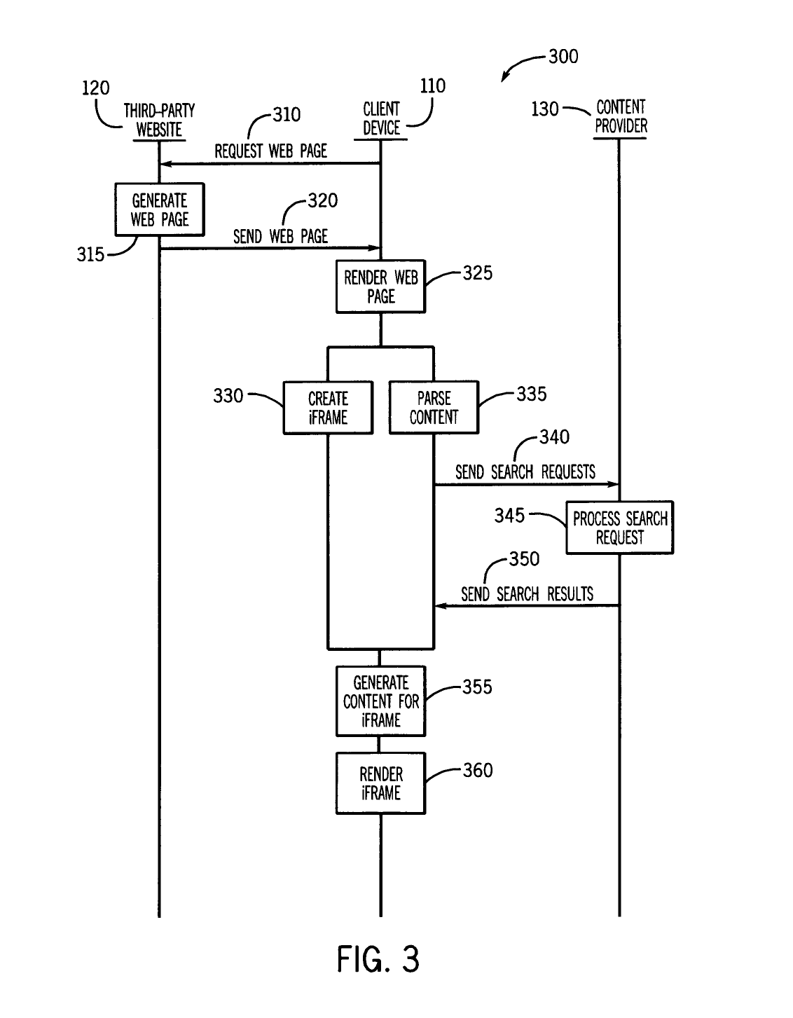

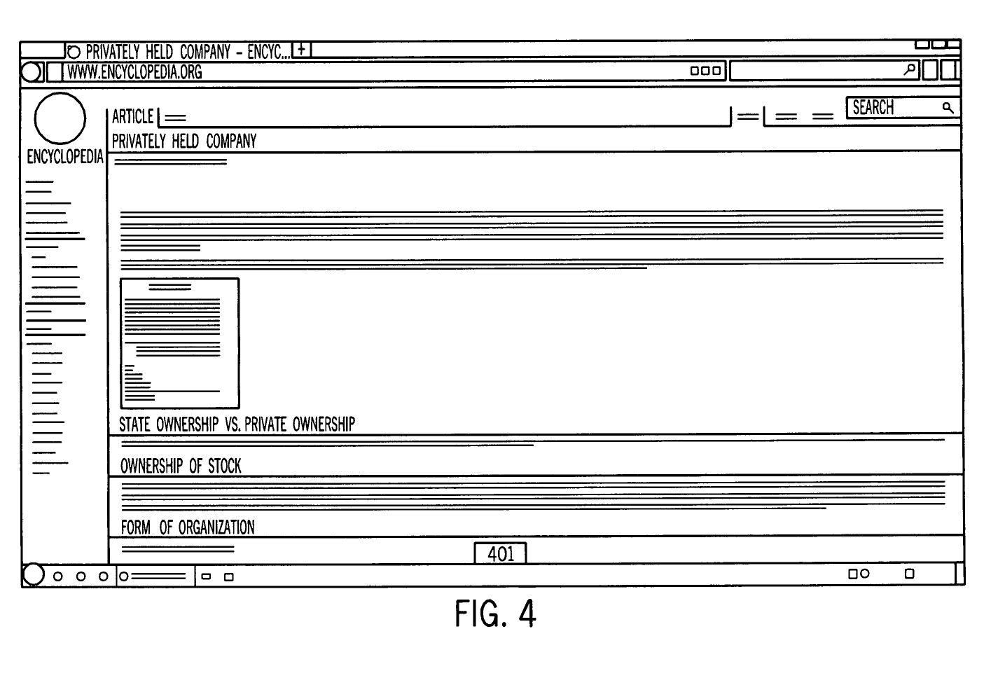

FIG. 3 is an interaction diagram of one embodiment of a process for providing relevancy of content to a user of a web browser navigating on a website. A client device 110, a third-party website 120 and a content provider 130 are seen. Initially, the client device 110 requests a web page 122 from the third-party website 120 (310). For example, a user of the client device 110 consults a web page 122 with a browser 112 operating on the client device 110. FIG. 4 is a screen shot of an example browser application 112. In this example, the user has loaded a third-party encyclopedia web page 122 containing a discussion about privately-held companies into a browser 112.

Referring back to FIG. 3, in response to the user requesting a web page 122, the third-party website 120 generates the requested web page 122 using stored data (315). For example, the third-party website 120 generates a markup language document 116 describing the content and formatting of the web page 122. Then, the third-party website 120 sends the markup language document 116 describing the generated web page 122 to the client device 110 through the network 140 (320). After receiving the markup language document 116, the browser 112 renders or starts rendering the web page 122 based on the content and formatting instructions included in the markup language document 116 (325).

Referring back to FIG. 3, in addition to rendering the web page 122 in the browser 112, the client device 110 executes the browser extender 114 to create a widget 118 comprising an iframe inserted in the web page (330). In one embodiment, the widget 118 comprises instructions that, when executed by a browser 112, retrieve data from the content provider 130 and inserts content based on the information retrieved in the widget 118. The widget 118 comprises an iframe directed at a uniform resource locator (URL) address, or other web page identifier, and may also include one or more parameters describing presentation of the iframe and its content by the browser 112 of the user device 110.

For example, the widget 118 may comprise an instruction such as <iframe id=“bgrSandbox” src=“http://sandbox.biggerpan.com” style=“border: 0 pt none; padding: 0 pt; width: 110 px; height: 35 px; background-color: transparent; visibility: visible; display: block; left: 50%; margin-left: −55 px; bottom: 0 px; position: fixed; z-index: 996; overflow: hidden;”></iframe>, which generates an iframe with an identifier parameter (in the present case “bgrSandbox”) allowing the browser extender 114 to further modify the display of the iframe using Cascading Style Sheets (CSS) instructions and to insert the content based on the information retrieved from the content providers 130 inside the iframe.

The browser extender 114 also parses content of the web page 122 (335) to select relevant keywords from the text content (230). The iframe creation (330) and the content parsing (335) can easily be switched, as the order of execution is irrelevant. The relevant keywords are used to request information from the content provider 130 via the network 140 (340).

Responsive to receiving the search request from the browser extender 114, the content provider 130 processes the search request (345). The content provider 130 then sends the search results to the client device 110 through the network 140 (350). From the search results, the browser extender 114 generates content for the widget 118 and inserts it in the iframe identified by a parameter (355). The browser application 112 then renders the iframe (360).

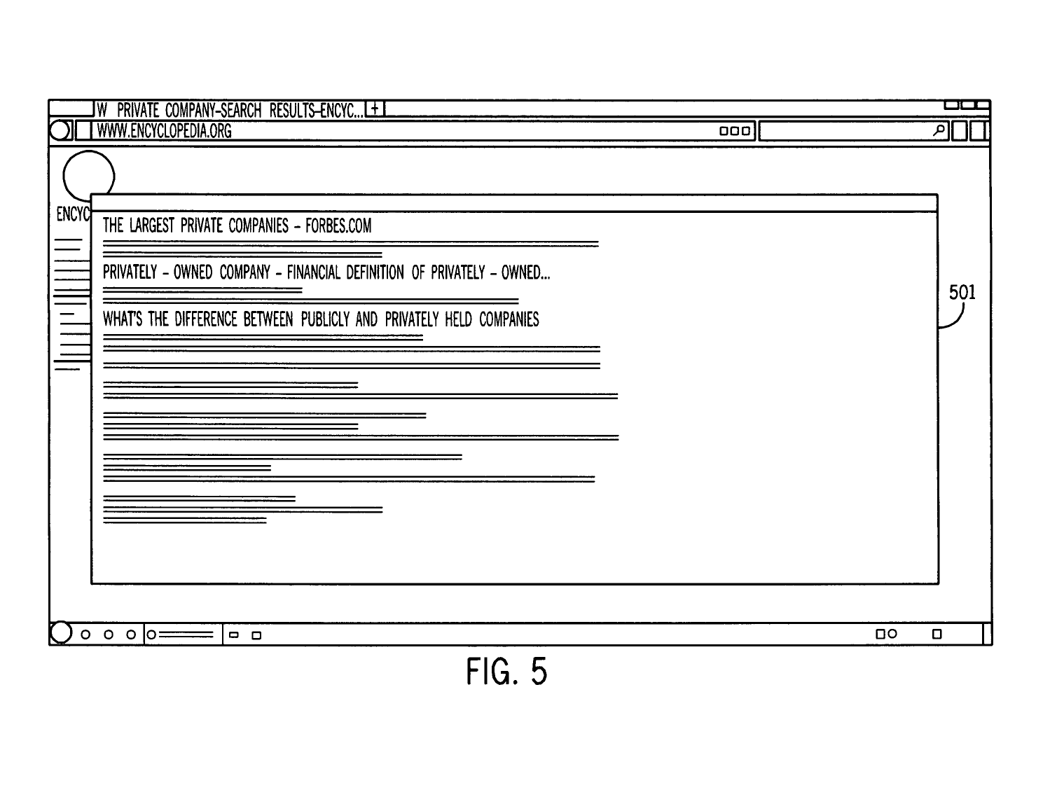

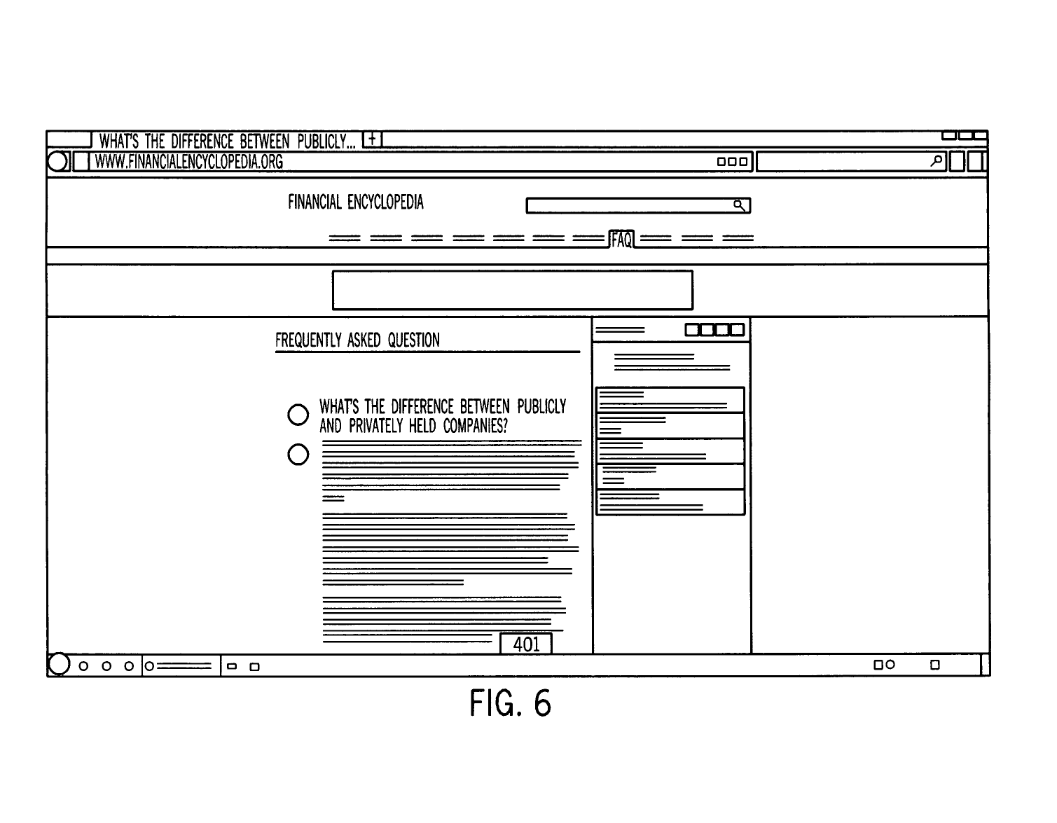

In one embodiment, a button is provided in the widget 118 that the user can click to visualize the content of the iframe in the widget 118. Referring to FIGS. 4 and 6, the button is represented by 401. When the user clicks the button 401, the iframe is resized to fit the screen and its content is displayed. For example, in FIG. 5 the frame 501 is displayed showing additional links with information with respect to private companies.

If the user selects a link to a website, that third-party website 120 generates the requested web page 122 using stored data. While or after receiving the markup language document 116, the browser 112 renders that third-party web page 122. For example, FIG. 6 is a screen shot with the selected website showing a third-party financial website containing a frequently asked question regarding the difference between a private and a publically traded company.

Thus, by utilizing the techniques of the present invention, users are provided a better user experience when browsing the Internet. The present invention provides a client-side internet tool that enables people to browse the web in a different fashion, offering users relevant links to access content directly related to the content viewed on a web page. Users can utilize the present invention to easily and seamlessly obtain relevant information related to any web page they consult.

While this specification contains many specifics, these should not be construed as limitations on the scope of what may be claimed, but rather as descriptions of particular implementations of the subject matter. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the techniques described herein should not be understood as requiring such separation in all aspects, and it should be understood that the described program components and systems can generally be integrated together in a single software product or packaged into multiple software products.

Although the subject matter has been described with a specific implementation, other alternatives, modifications, and variations will be apparent to those skilled in the art. Accordingly, the disclosure is intended to be illustrative, but not limiting, and such alternatives, modifications, and variations are within the spirit and scope of the following claims.

What is claimed is:

1. A method for obtaining information comprising:
requesting a web page from a web server;
receiving at a user device a markup language document for the requested web page;
rendering the web page;
parsing content of the web page to generate at least one keyword;
directing the at least one keyword to at least one content provider in at least one search request;
receiving processed search request results from the content providers;
creating a frame within the web page; and
rendering the frame, including content based on the information obtained from the content provider.

2. The method for obtaining information of claim 1 further comprising instantaneously parsing the content of web page while the web page is loading, in order to determine the keywords.

3. The method for obtaining information of claim 1 further comprising inserting into a frame a widget.

4. The method for obtaining information of claim 3 further comprising inserting into an iframe a widget.

5. The method for obtaining information of claim 1 further comprising inserting into a frame a widget contained within a markup language document.

6. The device of claim 5 wherein the markup language document is selected from the group consisting of HTML, XML, XHTML, and combinations thereof.

7. The method for obtaining information of claim 1 further comprising parsing content of the web page before creating a frame within the web page.

8. The method for obtaining information of claim 1 further comprising creating a frame within the web page before parsing content of the web page.

9. A client-side tool that enables people to browse the web comprising:
a browser configured to:
request a web page from a web server;
receive a markup language document for the requested web page;
render the web page; and
parse content of the web page to generate at least one keyword;
a browser extender configured to:
direct the at least one keyword to a content provider in a search request;
receive processed search request results from the content provider;
and
create a frame within the web page;
the browser further configured to render the frame, including the content based on the information obtained from the content provider;

10. The client-side tool of claim 9 wherein the browser is configured to instantaneously parse the content of web page while the web page is loading, in order to determine the at least one keyword.

11. The client-side tool of claim 9 wherein the browser extender is further configured to insert into a frame a widget.

12. The client-side tool of claim 9 wherein the browser extender is further configured to insert into a frame a widget contained within a markup language document.

13. The client-side tool of claim 12 wherein the browser extender is further configured to insert into a frame a widget contained within a markup language document selected from the group consisting of HTML, XML, XHTML, and combinations thereof.

14. The client-side tool of claim 9 wherein the browser is further configured to parse content of the web page before a frame is created within the web page.

15. The client-side tool of claim 9 wherein the browser is further configured to create a frame within the web page before content of the web page is parsed.

16. The client-side tool of claim 9 wherein the browser extender is selected from the group consisting of a plugin, extension or user script installed or executed in a web browser, a third-party software interacting with a web browser, and combinations thereof.
